(19) United States
(12) Patent Application Publication
(10) Pub. No.: US 2020/0061913 A1
(43) Pub. Date: Feb. 27, 2020

(54) LIFTING DEVICE FOR ADDITIVE MANUFACTURING AND OPERATIONAL METHOD THEREOF

(71) Applicant: TONGTAI MACHINE & TOOL CO., LTD., Kaohsiung City (TW)

(72) Inventors: Huai-en KAO, Kaohsiung City (TW); Hsin-pao CHEN, Kaohsiung City (TW); Jui-hsiung YEN, Kaohsiung City (TW)

(21) Appl. No.: 16/201,085

(22) Filed: Nov. 27, 2018

(30) Foreign Application Priority Data
Aug. 23, 2018 (CN) 201810965584.4

(51) Int. Cl. B29C 64/245; B33Y 10/00; B33Y 30/00; B33Y 40/00; B29C 64/153; B29C 64/357; B29C 64/321

(52) U.S. Cl. CPC B29C 64/245; B33Y 10/00; B33Y 30/00; B29C 64/321; B29C 64/153; B29C 64/357; B33Y 40/00

(57) ABSTRACT

A lifting device for additive manufacturing and an operational method thereof are provided. The lifting device has a base, a processing module, a powder feeding module, a linkage module, and a lifting module. The base is formed with a processing space and a powder feeding space. The processing module has a processing base, and the powder feeding module has a powder feeding base. The processing base and the powder feeding base are driven and moved by the lifting module. Thereby, two power sources of a traditional lifting device can be integrated into a single power source.

### CROSS REFERENCE TO RELATED APPLICATIONS

This application claims the priority of Chinese Application No. 201810965584.4, filed on Aug. 23, 2018, the disclosure of which is incorporated herein by reference.

### FIELD OF INVENTION

The present disclosure relates to a lifting device and an operational method thereof, and in particular to a lifting device for additive manufacturing and an operational method thereof.

### BACKGROUND OF INVENTION

Additive manufacturing technology is also known as three-dimensional (3D) printing or rapid prototyping technology. It is technology that uses adhesive material (such as powdered metal or plastic) or a fuse to construct an object by stacking up layers based on digital module data. Current commonly-used methods of additive manufacturing include laser powder melting, electron beam powder melting, laser coaxial feeding, and arc fuse shaping technology. Among them, the laser powder melting technology is a new type of additive manufacturing, and does not need traditional molds, tools, fixtures, and multiple processing operations. The laser powder melting technology can quickly and accurately make complex shape workpieces. Thus, freeform manufacturing can be achieved to solve difficulty in manufacturing many complex structural workpieces in the past. Number of processing operations is significantly reduced, and processing cycle is cut. The more complex structural products are, and the more evident the advantages are.

The traditional 3D printing device drives a processed workpiece to be lifted or lowered in a processing cavity by using a lifting device as a first power source, and pushes powders into the processing cavity by using another lifting device as a second power source. However, operation of controlling two power sources is complicated and the energy consumption is high. It is inconvenient for subsequent assembly, dis-assembly, and maintenance.

As a result, it is necessary to provide an improved lifting device for additive manufacturing and an operational method thereof to solve the problems existing in the conventional technologies, as described above.

### SUMMARY OF INVENTION

An object of the present disclosure is to provide a lifting device for additive manufacturing, wherein the lifting device move the processing base and the powder feeding base at the same time through driving the lifting module so that two power sources of a traditional lifting device can be integrated into a single power source.

To achieve the above object, the present disclosure provides a lifting device for additive manufacturing. The lifting device is disposed in a processing chamber of a three-dimensional printing equipment for additive manufacturing, and comprises a base, a processing module, a powder feeding module, a linkage module, and a lifting module. The base is disposed in the processing chamber and formed with a processing space configured to produce a processed workpiece and a powder feeding space configured to contain powders. The processing module comprises a processing base disposed in the processing chamber and a processing support rod disposed on a bottom of the processing base for supporting and moving the processing base upward/downward. The powder feeding module comprises a powder feeding base disposed in the powder feeding space and a powder feeding guider disposed on a bottom of the powder feeding base for supporting and moving the powder feeding base upward/downward. The linkage module comprises a fixed shaft disposed on a bottom of the base and a linkage component pivoted on the fixed shaft, wherein two ends of the linkage component are connected to the processing base and the powder feeding base, respectively, and the fixed shaft is configured to define a pivot for the linkage component so that the two ends of the linkage component move the processing base and the powder feeding base along two opposite directions, respectively. The lifting module is disposed below the linkage module, wherein the lifting module comprises a lifting base configured to connect to the processing support rod, and a lifting rod disposed on a bottom of the lifting base for supporting and moving the lifting base upward/downward.

In one embodiment of the present disclosure, the linkage module comprises a connecting element pivoted on the fixed shaft, a processing extension element pivoted on a first end of the connecting element, and a powder feeding extension element pivoted on a second end of the connecting element.

In one embodiment of the present disclosure, a pivot of the connecting element is pivoted on the fixed shaft, and a ratio of a first length to a second length is 1:1, wherein the first length is from the pivot of the connecting element to the first end, and the second length is from the pivot of the connecting element to the second end.

In one embodiment of the present disclosure, the powder feeding guider comprises a powder feeding support rod disposed on the bottom of the powder feeding base for supporting and moving the powder feeding base upward/downward, and a limiting portion through which the powder feeding support rod passes, wherein the limiting portion is configured to limit the powder feeding support rod to move upward/downward.

In one embodiment of the present disclosure, the base is further formed with a recycling powder tank configured to recycle the powders.

In one embodiment of the present disclosure, the processing module further comprises a processing plate disposed on a top of the processing base.

In one embodiment of the present disclosure, the base comprises a body and an engaging portion extending from a periphery of the body, and the engaging portion is configured to engage against a bottom of the processing chamber.

In one embodiment of the present disclosure, the lifting base comprises a positioning portion configured to connect to the processing support rod.

To achieve the above object, the present disclosure provides an operational method of a lifting device for additive manufacturing. The operational method comprises: a preparing step of moving the processing base of the processing module to a top of the processing space, while moving the powder feeding base of the powder feeding module to a bottom of the powder feeding space and feeding the powders into the powder feeding space; a powder feeding step of pushing the powders into the processing space through using a wiper of the three-dimensional printing equipment, and pushing the remaining of the powders from the processing space into a recycling powder tank by using the wiper; a printing step of fusing the powders in the processing space through using a laser device of the three-dimensional printing equipment to produce a processed workpiece; and a lowering step of driving the lifting base to move the processing base downward so that the linkage component moves the powder feeding base upward and the powders in the powder feeding space is pushed upward, and then returning to the powder feeding step until the processed workpiece is completely manufactured.

In one embodiment of the present disclosure, in the lowering step, a moving distance that the powder feeding base is moved upward is one time or more of a moving distance that the processing base is moved down.

As described above, the lifting device for additive manufacturing of the present disclosure move the processing base and the powder feeding base at the same time through driving the lifting module. Thereby, two power sources of a traditional lifting device can be integrated into a single power source. In addition, a size of the processing chamber can be the size general processing cavity, and the processing space and the powder feeding space can be reduced through mounting the base on the processing chamber, wherein decreasing the printing area can reduce the loss of the powders, and it is also convenient to assemble, disassemble, and maintain the base.

### DESCRIPTION OF DRAWINGS

FIG. 1 is a schematic view of a processing base and a powder feeding base of a lifting device for additive manufacturing located at an origin point of a process according to a preferred embodiment of a present disclosure.

FIG. 2 is a schematic view of the processing base of the lifting device for additive manufacturing moved to a middle of a processing space according to a preferred embodiment of the present disclosure.

FIG. 3 is schematic view the processing base of the lifting device for additive manufacturing moved to a bottom of the processing space according to a preferred embodiment of the present disclosure.

FIG. 4 is a flowchart of an operational method of the lifting device for additive manufacturing according to a preferred embodiment of the present disclosure.

### DETAILED DESCRIPTION OF PREFERRED EMBODIMENTS

The structure and the technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, etc., are only directions by referring to the accompanying drawings, and thus the used directional terms are used to describe and understand the present disclosure, but the present disclosure is not limited thereto.

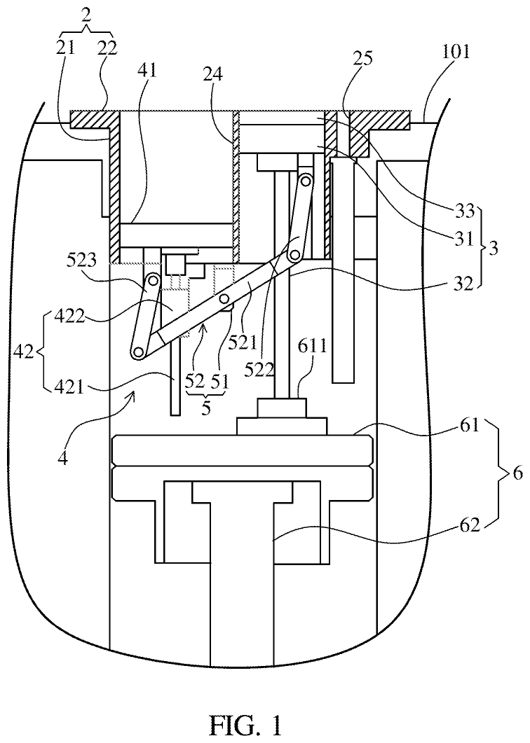

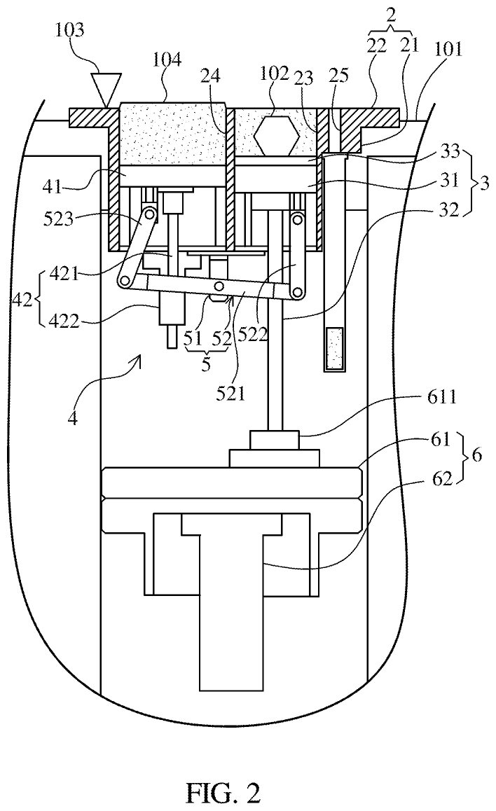

Referring to FIGS. 1 and 2, a lifting device for additive manufacturing according to the preferred embodiment of the present disclosure is illustrated, wherein the lifting device is disposed in a processing chamber 101 of a three-dimensional printing equipment for additive manufacturing and comprises a base 2, a processing module 3, a powder feeding module 4, a linkage module 5, and a lifting module 6. The detailed structure of each component, assembly relationships, and principles of operation for the present invention will be described in detail hereinafter.

Referring to FIGS. 1 and 2, the base 2 is disposed in the processing chamber 101, the base 2 comprises a body 21 and an engaging portion 22, wherein engaging portion 22 extends from a periphery of the body 21, and the engaging portion 22 is configured to engage against a bottom of the processing chamber 101. In addition, the body 21 of the base 2 is formed with a processing space 23, a powder feeding space 24, and a recycling powder tank 25, wherein the processing space 23 is configured to produce a processed workpiece 102, the powder feeding space 24 configured to contain powders 104, and the recycling powder tank 25 is configured to recycle the powders 104.

Referring to FIGS. 1 and 2, the processing module 3 comprises a processing base 31, a processing support rod 32, and a processing plate 33, wherein the processing base 31 is disposed in the processing chamber 101, the processing support rod 32 is disposed on a bottom of the processing base 31 for supporting and moving the processing base 31 upward/downward, and the processing plate 33 is disposed on a top of the processing base 31. The processing plate 33 is configured to carry the powders 104 to be fused and the processed workpiece 102 that is fused.

Referring to FIGS. 1 and 2, the powder feeding module 4 comprises a powder feeding base 41 and a powder feeding guider 42, wherein the powder feeding base 41 is disposed in the powder feeding space 24, and the powder feeding guider 42 is disposed on a bottom of the powder feeding base 41 for supporting and moving the powder feeding base 41 upward/downward.

Furthermore, the powder feeding guider 42 comprises a powder feeding support rod 421 and a limiting portion 422, wherein the powder feeding support rod 421 is disposed on the bottom of the powder feeding base 41 for supporting and moving the powder feeding base upward/downward, and the limiting portion 422 through which the powder feeding support rod 421 passes, wherein the limiting portion 422 is configured to limit the powder feeding support rod 421 to move upward/downward.

Referring to FIGS. 1 and 2, the linkage module 5 comprises a fixed shaft 51 and a linkage component 52, wherein the fixed shaft 51 disposed on a bottom of the base 2, and the linkage component 52 is pivoted on the fixed shaft 51, and two ends of the linkage component 52 are connected to the processing base 31 and the powder feeding base 41, respectively. The fixed shaft 51 is configured to define a pivot for the linkage component 52 so that the two ends of the linkage component 52 move the processing base 31 and the powder feeding base 41 along two opposite directions, respectively. For example, the processing base 31 is moved downward, and the powder feeding base 41 is moved upward. Furthermore, the linkage module 52 comprises a connecting element 521, a processing extension element 522, and a powder feeding extension element 523, wherein the connecting element 521 is pivoted on the fixed shaft 51, the processing extension element 522 is pivoted on a first end of the connecting element 521 and the processing base 31, and the powder feeding extension element 523 is pivoted on a second end of the connecting element 521 and the powder feeding base 41. In the embodiment, a pivot of the connecting element 521 is pivoted on the fixed shaft 51. Preferably, a ratio of a first length to a second length is 1:1, wherein the first length is from the pivot of the connecting element 521 to the first end, and the second length is from the pivot of the connecting element 521 to the second end. In addition, the location of the pivot of the connecting element 521 pivoted on the fixed shaft 51 can depend site condition to adjust the ratio of the first length to the second length, so that a distance that the powder feeding base 41 is moved upward is 1, 1.25, 1.5, 2 or more times of a distance that the processing base 31 is moved downward, thus, the supply amount of the powders can be controlled.

Referring to FIGS. 1 and 2, the lifting module 6 is disposed below the linkage module 5, and the lifting module 6 comprises a lifting base 61 and a lifting rod 62, wherein the lifting base 61 is configured to connect to the processing support rod 32, and the lifting rod 62 is disposed on a bottom of the lifting base 61 for supporting and moving the lifting base 61 upward/downward. In addition, the lifting base 61 comprises a positioning portion 611, the positioning portion 611 is configured to connect to the processing support rod 32 to strengthen the structure of the processing support rod 32.

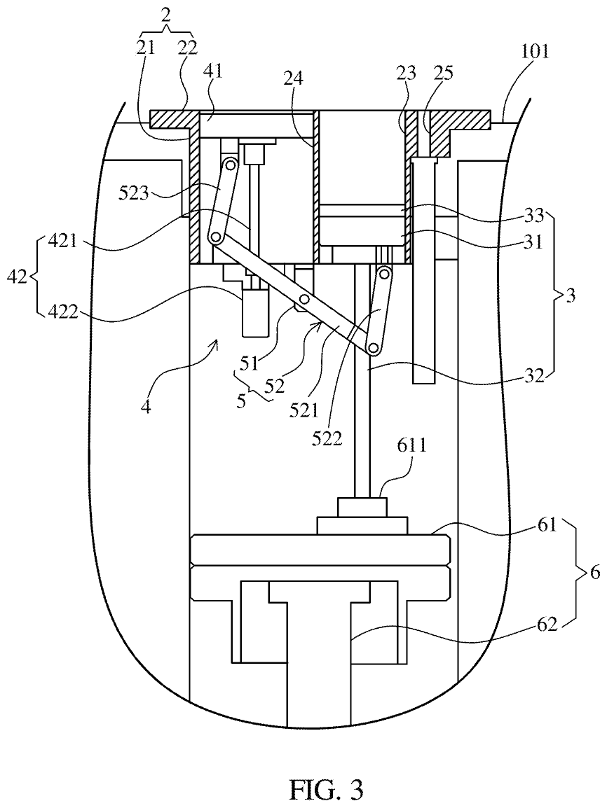

According to the described structure, as shown in FIG. 1, the processing base 31 and the powder feeding base 41 are located at the original point of the process. Namely, the processing base 31 is located at a top of the processing space 23, and the powder feeding base 41 is located at a bottom of the powder feeding space 24. At the beginning of the process, the lifting base 61 is driven to move the processing base 31 to a lower level so that the linkage component 5 moves the powder feeding base 41 upward and the powders 104 in the powder feeding space 24 is pushed upward (shown in FIG. 2). While the powders 104 are pushed from the powder feeding space 24 into the processing space 23 through using a wiper 103 of the three-dimensional printing equipment, and the remaining of the powders 104 is pushed from the processing space 23 into a recycling powder tank 25 by using the wiper 103. The powders 104 is then located at a specific location is fused in the processing space 23 through using a laser device (not shown) of the three-dimensional printing equipment to produce a processed workpiece 102 with a predetermined three-dimensional shape. Returning to move the processing base 31 downward, and the powder feeding base 41 is moved upward, and then the powders 104 is pushed upward into the processing space 23. Finally, the powder feeding base 41 is located at a top of the powder feeding space 24 (shown in FIG. 3). When the process is completely manufactured, the processing base 31 is moved upward and the powder feeding base 41 are moved downward to the original point of the process (shown FIG. 1). After replacing the recycling powder tank 25 and replenishing the powders 104 in the powder feeding space 24, another process can be implemented.

As described above, the lifting device for additive manufacturing of the present disclosure move the processing base 31 and the powder feeding base 41 at the same time through driving the lifting module 6 (single power source). Thereby, two power sources of a traditional lifting device can be integrated into a single power source. In addition, a size of the processing chamber 101 can be the size general processing cavity, and the processing space 23 and the powder feeding space 24 can be reduced through mounting the base 2 on the processing chamber 101, wherein decreasing the printing area can reduce the loss of the powders 104, and it is also convenient to assemble, disassemble, and maintain the base 2.

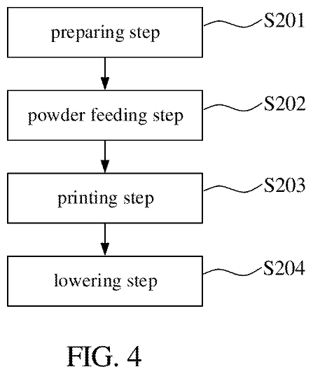

Referring to FIG. 4 in conjunction with FIGS. 1 and 2, an operational method of a lifting device for additive manufacturing is provided and operated by said lifting device for additive manufacturing, wherein the operational method comprises a preparing step S201, a powder feeding step S202, a printing step S203, and a lowering step S204. The detailed principles of operation for the present invention will be described in detail hereinafter.

Referring to FIG. 4 in conjunction with FIGS. 1 and 2, in the preparing step S201, the processing base 31 of the processing module 3 is moved to a top of the processing space 23, while the powder feeding base 41 of the powder feeding module 4 to a bottom of the powder feeding space 24 (original point of the process) and the powders 104 are fed into the powder feeding space 24.

Referring to FIG. 4 in conjunction with FIGS. 1 and 2, in the powder feeding step S202, the powders 104 are pushed into the processing space 23 through using a wiper 103 of the three-dimensional printing equipment, and the remaining of the powders 104 is pushed from the processing space 23 into a recycling powder tank 25 by using the wiper 103.

Referring to FIG. 4 in conjunction with FIGS. 1 and 2, in the printing step S203, the powders 104 located at a specific location is fused in the processing space 23 through using a laser device (not shown) of the three-dimensional printing equipment to produce a processed workpiece 102 with a predetermined three-dimensional shape.

Referring to FIG. 4 in conjunction with FIGS. 1 and 2, in the lowering step S204, the lifting base 61 is driven to move the processing base 31 downward so that the linkage component 5 moves the powder feeding base 41 upward and the powders 104 in the powder feeding space 24 is pushed upward, and then returning to the powder feeding step S203 until the processed workpiece 102 is completely manufactured. In the embodiment, a distance that the powder feeding base 41 is moved upward is 1 or more times of a distance that the processing base 31 is moved downward,

As described above, the lifting device for additive manufacturing of the present disclosure move the processing base 31 and the powder feeding base 41 at the same time through driving the lifting module 6 (single power source). Thereby, two power sources of a traditional lifting device can be integrated into a single power source. In addition, a size of the processing chamber 101 can be the size general processing cavity, and the processing space 23 and the powder feeding space 24 can be reduced through mounting the base 2 on the processing chamber 101, wherein decreasing the printing area can reduce the loss of the powders 104, and it is also convenient to assemble, disassemble, and maintain the base 2.

The present disclosure has been described with preferred embodiments thereof and it is understood that many changes and modifications to the described embodiments can be carried out without departing from the scope and the spirit of the invention that is intended to be limited only by the appended claims.

What is claimed is:

1. A lifting device disposed in a processing chamber of a three-dimensional printing equipment for additive manufacturing, comprising:
a base disposed in the processing chamber and formed with a processing space configured to produce a processed workpiece and a powder feeding space configured to contain powders;
a processing module comprising a processing base disposed in the processing chamber and a processing support rod disposed on a bottom of the processing base for supporting and moving the processing base upward/downward;
a powder feeding module comprising a powder feeding base disposed in the powder feeding space and a powder feeding guider disposed on a bottom of the powder feeding base for supporting and moving the powder feeding base upward/downward;
a linkage module comprising a fixed shaft disposed on a bottom of the base and a linkage component pivoted on the fixed shaft, wherein two ends of the linkage component are connected to the processing base and the powder feeding base, respectively, and the fixed shaft is configured to define a pivot for the linkage component so that the two ends of the linkage component move the processing base and the powder feeding base along two opposite directions, respectively; and
a lifting module disposed below the linkage module, wherein the lifting module comprises a lifting base configured to connect to the processing support rod, and a lifting rod disposed on a bottom of the lifting base for supporting and moving the lifting base upward/downward.

2. The lifting device according to claim 1, wherein the linkage module comprises a connecting element pivoted on the fixed shaft, a processing extension element pivoted on a first end of the connecting element, and a powder feeding extension element pivoted on a second end of the connecting element.

3. The lifting device according to claim 2, wherein a pivot of the connecting element is pivoted on the fixed shaft, and a ratio of a first length to a second length is 1:1, wherein the first length is from the pivot of the connecting element to the first end, and the second length is from the pivot of the connecting element to the second end.

4. The lifting device according to claim 1, wherein the powder feeding guider comprises a powder feeding support rod disposed on the bottom of the powder feeding base for supporting and moving the powder feeding base upward/downward, and a limiting portion through which the powder feeding support rod passes, wherein the limiting portion is configured to limit the powder feeding support rod to move upward/downward.

5. The lifting device according to claim 1, wherein the base is further formed with a recycling powder tank configured to recycle the powders.

6. The lifting device according to claim 1, wherein the processing module further comprises a processing plate disposed on a top of the processing base.

7. The lifting device according to claim 1, wherein the base comprises a body and an engaging portion extending from a periphery of the body, and the engaging portion is configured to engage against a bottom of the processing chamber.

8. The lifting device according to claim 1, wherein the lifting base comprises a positioning portion configured to connect to the processing support rod.

9. An operational method of a lifting device for additive manufacturing according to claim 1, comprising steps of:
a preparing step of moving the processing base of the processing module to a top of the processing space, while moving the powder feeding base of the powder feeding module to a bottom of the powder feeding space and feeding the powders into the powder feeding space;
a powder feeding step of pushing the powders into the processing space through using a wiper of the three-dimensional printing equipment, and pushing the remaining of the powders from the processing space into a recycling powder tank by using the wiper;
a printing step of fusing the powders in the processing space through using a laser device of the three-dimensional printing equipment to produce a processed workpiece; and
a lowering step of driving the lifting base to move the processing base downward so that the linkage component moves the powder feeding base upward and the powders in the powder feeding space is pushed upward, and then returning to the powder feeding step until the processed workpiece is completely manufactured.

10. The operational method according to claim 9, wherein in the lowering step, a moving distance that the powder feeding base is moved upward is one time or more of a moving distance that the processing base is moved down.
